(19) United States
(12) Patent Application Publication
(10) Pub. No.: US 2024/0380713 A1
(43) Pub. Date: Nov. 14, 2024

(54) Fully Managed, Frictionless Financial Information Exchange Engine for Financial Transaction Messaging

(71) Applicant: Lakshminarayan Kuve, McKinney, TX (US)

(72) Inventor: Lakshminarayan Kuve, McKinney, TX (US)

(21) Appl. No.: 18/658,775

(22) Filed: May 8, 2024

Related U.S. Application Data
(60) Provisional application No. 63/500,853, filed on May 8, 2023.

(51) Int. Cl. H04L 51/04; G06F 9/50; H04L 45/42

(52) U.S. Cl. CPC H04L 51/04; G06F 9/5027; H04L 45/42

(57) ABSTRACT

The present invention provides a financial information exchange (FIX) engine which enables a client to deploy the system with minimal investment in specialized knowledge. The client is empowered by abstracting the technical aspects of the system through its interface, allowing them to fully configure, deploy, and manage the platform without needing to be familiar with the underlying infrastructure. The engine itself is configured to operate without the specialized infrastructure necessary for most available FIX systems by being structured as Software as a Service (SaaS). The result is an effective, frictionless FIX engine at a much lower cost.

### FIELD OF THE INVENTION

The present invention relates generally to a financial information exchange protocol. More specifically, the present invention is a device that allows institutions to communicate with each other without extensive skill or expertise with financial information exchange protocols.

### BACKGROUND OF THE INVENTION

Within the current markets financial information exchange (FIX) protocol is currently used to facilitate the exchange of financial information between various parties such as banks, stock exchanges, other financial institutions and regulatory authorities. FIX Engine platforms provide a secure and standardized way to share and access financial information by authorized users for more efficient and transparent financial transactions. Most of the current FIX engine platforms utilize technology and protocols which requires large upfront investments in infrastructures and technical staff that know how to deploy and manage the platform correctly. These FIX platforms require technical staff to manage it as an on-premises product or require an operational agreement between supplier and client to manage all configurations modifications to client engines, requiring clients to be working with the supplier's schedule for all implementations.

An objective of the present invention is to provide users with a platform that abstracts all the technical infrastructure away from the client and gives clients' full power to configure and manage, with a small learning curve, to help eliminate the need for technical staff. The present invention intends to provide users with a device that disrupts the industry where this is a complex product requiring expensive licenses and operational expenses, making it especially hard for smaller firms to acquire and use. In order to accomplish that, a preferred embodiment of the present invention comprises the steps of the user entering information into a graphical user interface, configuring and setting up a FIX engine based on the information, and deploying a FIX engine. Thus, the present invention is a fully managed, frictionless FIX engine that allows a user to configure and launch a FIX engine without needing to understand any underlying technology that drives the software.

### SUMMARY OF THE INVENTION

The present invention is a process for setting up and deploying a frictionless FIX engine to help with reducing high costs and maintenance products usually required to operate a FIX engine. The present invention seeks to provide users with a device that enables real time internal message routing between two isolated sessions. The underlying messaging between sessions internally are performed using a redis infrastructure and provide a low latency, first-in-first-out messaging. In order to accomplish this in the present invention, operators access the user interface (UI) to provide information on linking between sessions (called routing rules). Further, the process sets up a FIX engine based on that information and a FIX engine is then deployed. Thus, the present invention is a fully managed, frictionless FIX engine that allows a user to configure and launch a FIX engine without needing to understand any underlying technology that drives the software, but just understand the required workflow wherein to route messages from incoming source to an outbound destination.

### BRIEF DESCRIPTION OF THE DRAWINGS

FIG. 1 is a flow diagram for an embodiment of the present invention.

FIG. 2 is a flow diagram for an embodiment of the inbound messaging flow.

FIG. 3 is a flow diagram for an embodiment of the outbound messaging flow.

FIG. 4 is a flow diagram for an embodiment of the user/present invention interactions.

### DETAIL DESCRIPTIONS OF THE INVENTION

All illustrations of the drawings are for the purpose of describing selected versions of the present invention and are not intended to limit the scope of the present invention.

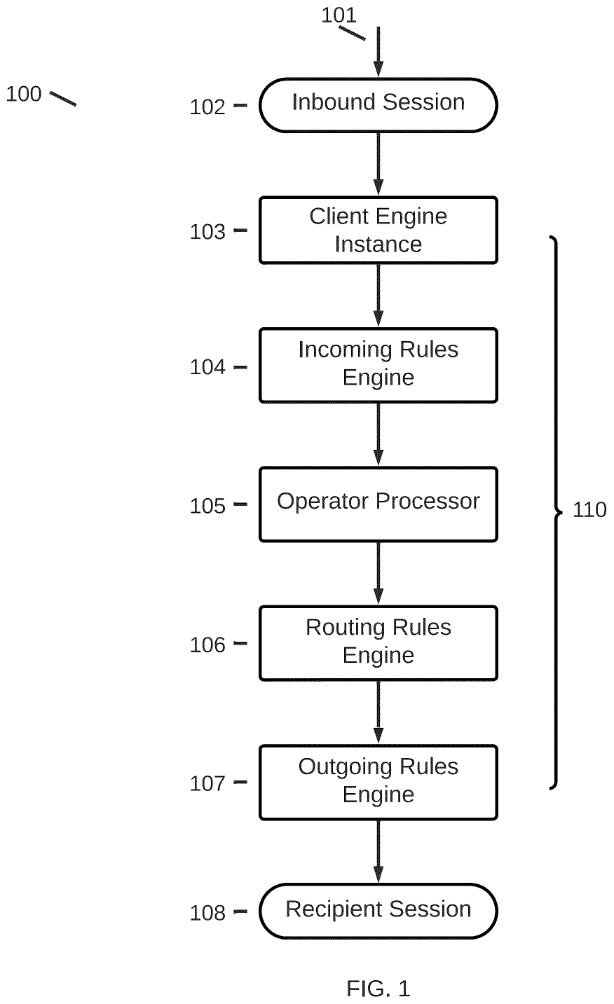

As shown in FIG. 1-4, the present invention is a fully managed, frictionless FIX engine that is offered as a software solution. An objective of the present invention is to provide users with a FIX engine without the user needing any technological knowledge to set up and start a FIX engine for their company or institution. The present invention intends to provide users with a process that provides the user with a FIX engine that transmits and receives messages between financial institutions. To accomplish this the present invention starts with the user providing information, setting up a FIX engine based on the information, and deploying the FIX engine. These steps are executed in sequential order. Thus, the present invention is a fully managed, frictionless FIX engine that allows a user to configure and launch a FIX engine without needing to understand any underlying technology that drives the software.

The present invention begins with the user providing information. The user utilizes the online server to create a user account that is linked to the user and their business. In its preferred embodiment once the user account is registered an administrator on the backend will approve or deny the user account. The user is then provided with login authentication credentials to access a website on the online server. The user utilizes a graphical user interface (GUI) to enter information about their business infrastructure that requires a FIX engine. Once the user registration is approved a network load balancing (NLB) instance is created. The GUI allows users to configure, customize, and deploy FIX Engines. It should be further noted that the user can provide information in various ways while still staying within the scope of the present invention.

The online server and backend then set up a FIX engine based on the information provided by the user. The backend creates and configures an engine instance and adds various sessions before the FIX engine is ready for deployment. For each session a session, a plurality of rules, a plurality of routes, and a custom processor are all configured. The plurality of rules and the custom processor are both tested to ensure each work properly. The backend software then creates docker images. These docker images have a repository that captures and persists images associated with client configured engines. Further, an In-Memory Redis database instance is provisioned, to capture engine messaging and real-time FIX transaction logs. Additionally, there is a special search component that allows full search capability into the FIX transactional logs. These transactional logs can be further analyzed with artificial intelligence and machine learning systems. To ensure there is no data loss a relational database is configured for the present invention where all engine configuration is backed up for permanent storage and recovery. Furthermore, the present invention supports container orchestration that launches, starts, restarts, and shuts down engine instances on-demand and/or on-schedule. An additional security architecture is implemented that isolates every client implementation stack.

Once the FIX engine has been configured with the information provided by the user the FIX engine can be deployed for full use by the user. The docker container images are then uploaded into a container registry after user configuration is saved and a deploy command issued. For each engine an image is created, configured, and launched as a container which is then set to be automatically recoverable and can contain a scaling component to allow for usage growth or shrinkage. The GUI then presents the user with a dashboard that provides a near real time statistical view of the activity within each engine. Furthermore, the user pays a monthly subscription service fee for access to the GUI that shows their customized FIX engine. This design allows for the present invention to provide an infrastructure free, software development free FIX engine that is fully managed. With all the components working in tandem with each other it can be seen that, the present invention is a fully managed, frictionless FIX engine that allows a user to configure and launch a FIX engine without needing to understand any underlying technology that drives the software.

FIG. 1 demonstrates the flow of communication for a message (101) through the system (100). The message (101) originates from a client's inbound session (102) and is transmitted to the client's instance of the engine (103) available through the operator's infrastructure (110). The engine instance (103) evaluates the message and applies a configured set of rules through its incoming rules engine component (104). This evaluation is conducted by the operator's processor (105), governed by processor resource reservation. The processor (105) is instructed on how to route the information according to the routing rules (106) resulting from this evaluation. Once the destination is determined, the message is processed through an outgoing rules engine (107) to be transmitted to one or more recipient session(s) (108).

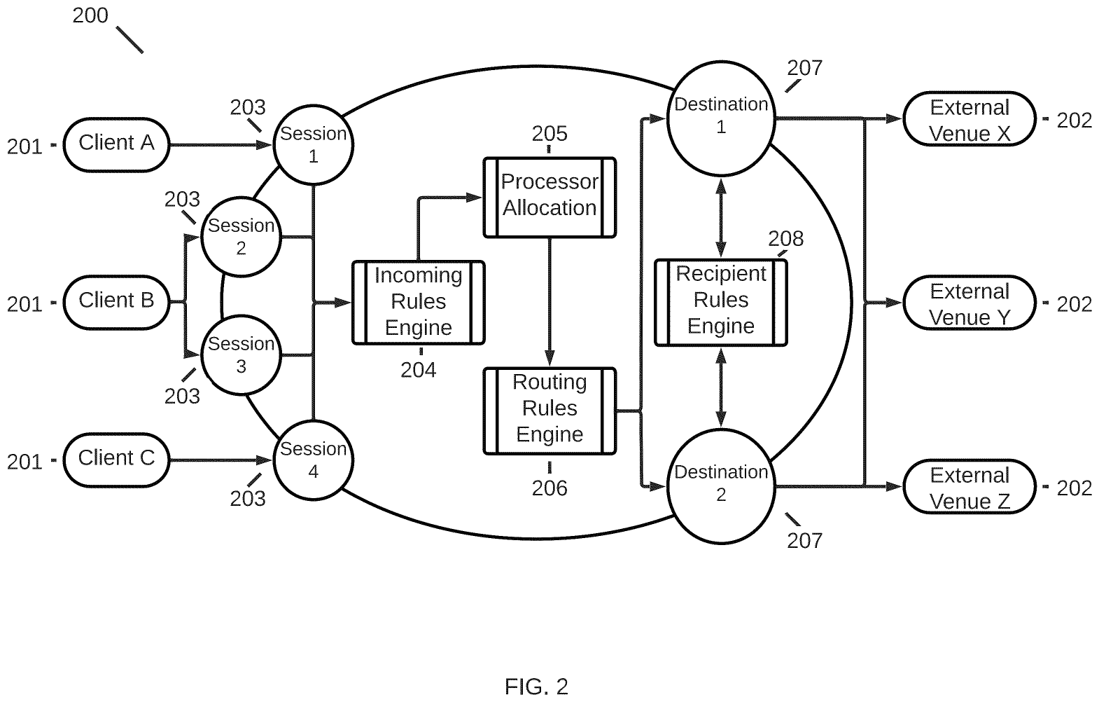

FIG. 2 describes an overview of how the system (200) handles multiple clients (201) and recipients (202). Each client (201) may have access to one or more sessions (203) which serve as the interface to the operator's system (200). Each session provides messages to the rules engine (204), which assigns rules according to the session (203) from which a message is received. Each message is allocated processor resources (205) assigned for a given session (203), which may vary depending on level of subscription. Some embodiments may allow for processor resource allocation (205) to depend on additional factors, such as current traffic. Once each message's rules are processed, the routing rules engine (206) directs the messages towards their destination (207). Destinations (207) may have a destination rules engine (208) governing how their messages are transmitted. Once routed to their destination (207), messages can be accessed by external recipient venues (202).

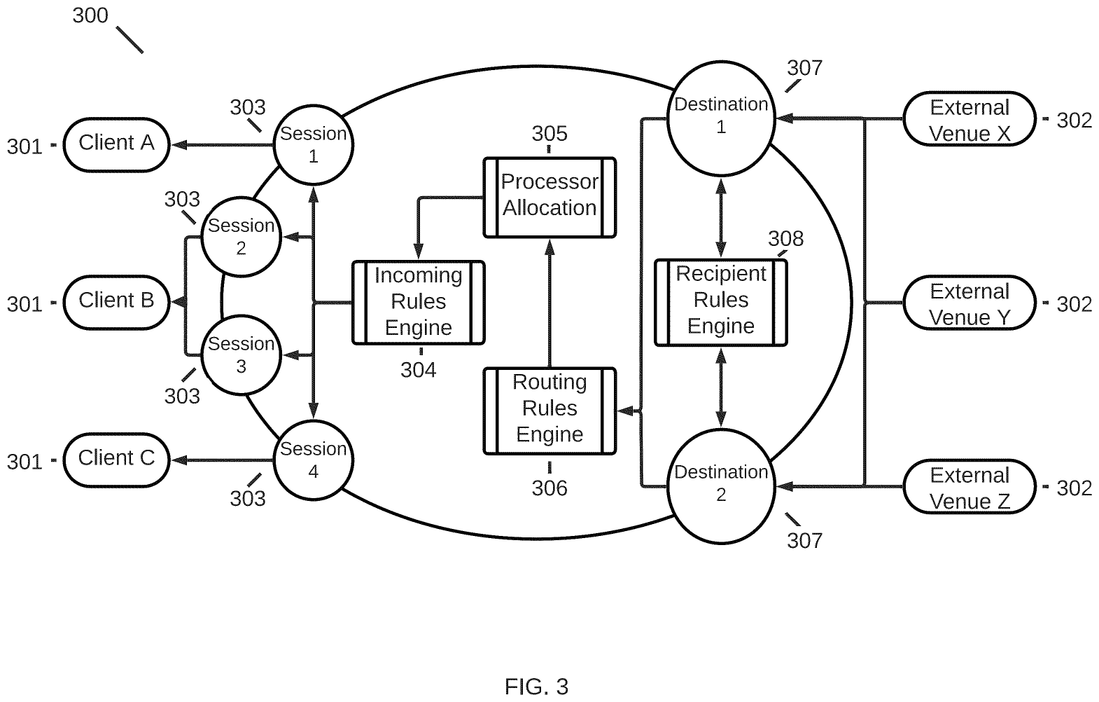

FIG. 3 describes how response messaging flows back to the clients. The recipient venue (302) may provide a response through the destination interface (307). The destination rules engine (308) may apply specific rules to aid in the communication. The response is placed back in the routing rules engine (306) to determine the appropriate client session. The resources allocated to the relevant client session (305) then process the response to have response rules applied in the rules engine (304). The rules engine (304) then provides the client (301) access to the response through the client's session interface (303).

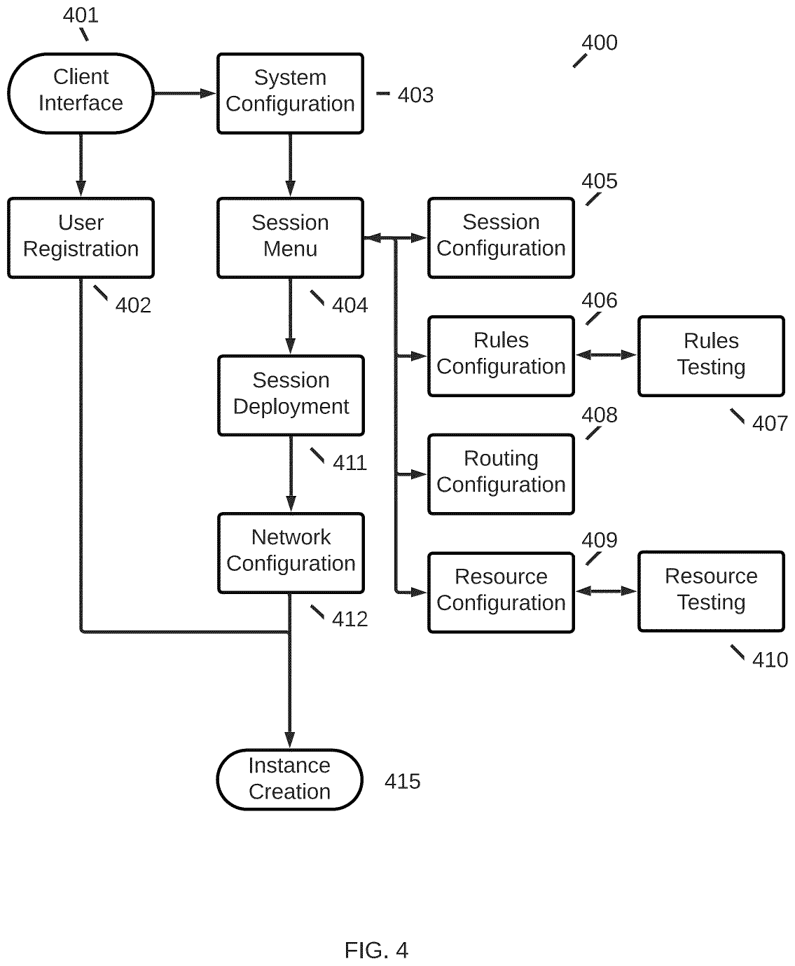

FIG. 4 provides an overview for how the client's access is set up. The client (401) accesses the system (400) through its user interface. This access allows a client user (401) to register for access (402) and configure how they can access the system (403). Some embodiments may allow a client (401) to create pre-configured sessions from a selection of templated options or begin their configuration from that point. Some embodiments would allow a client to create additional sessions at this step. Once a user (401) has elected to access the session menu (404) they have several configuration options from which to choose. The first option (405) would be to configure the session as a whole. The second option would be to configure the rules (406) associated with the session and subsequently test those rules (407). The third option would be to configure how messages are routed (408). The fourth option would be to configure their processing resource allocation (409) and subsequently test the resulting processor performance (410). Once all configuration options have been finalized, the client (401) may then deploy the new or reconfigured session (411). Upon deployment, a configuration of the physical network elements for transmission (412) would then be set and tested. Once this final test is satisfied and/or when registration is finalized, an NLB instance (415) is created to help manage the underlying network.

Although the invention has been explained in relation to its preferred embodiment, it is to be understood that many other possible modifications and variations can be made without departing from the spirit and scope of the invention.

1. A financial information exchange (FIX) service method comprising:
providing a backend infrastructure, the infrastructure comprising:
one or more servers each comprising one or more processors and some amount of non-transitory storage media; and
an internal network;
wherein:
servers beyond the first are interconnected with the first and each other through the internal network;
the servers are configured to dynamically allocate processing resources; and
the servers are accessible from outside the internal network by connection to external networks;
providing a client session instance, the instance comprising:
a user interface;
a session configuration;
a session rules engine;
a routing rules engine; and
a processor resource allocation;
wherein:
the session configuration is stored on the non-transitory storage media of the servers;
the processors on the servers are configured to execute the session rules engine according to the processor resource allocation for the client session;
the processors on the servers are configured to route messages from the user through the routing rules engine;
the user interface is configured to allow the user to remotely manage the session configuration, session rules engine, routing rules engine, and processor resource allocation from an external network;
the user interface is configured to enable the user to compose, send, and peruse messages within the interface;
and
providing a destination session instance, the instance comprising:
a recipient interface; and
a recipient rules engine;
wherein:
the recipient interface is configured to allow a recipient to receive and/or reply to messages within the interface;
the recipient rules engine is configured to enable the backend infrastructure to interface with the recipient; and
the processors on the servers are configured to execute the recipient rules engine;
wherein:
a user generates a message through the user interface;
the client session instance processes the message for transmission using the session rules engine through the session's designated processor resource allocation;
the routing rules engine determines how and where to route the message;
the recipient rules engine processes the message for any recipient requirements;
the destination session instance transmits the message through the recipient interface to a recipient.

2. The method of claim 1 further wherein:
a recipient then generates a response through the recipient interface;
the recipient rules engine processes the response to be provided to the user session;
the routing rules engine directs the response to the appropriate client session instance;
the client session instance processes and stores the response for perusal by the user; and
the user accesses the response through the user interface.

3. The method of claim 1 wherein the user interface is an application programming interface (API).

4. The method of claim 3 wherein the API is accessed through a web browser interface.

5. The method of claim 3 wherein the API is accessed through a dedicated software application.

6. The method of claim 5 wherein the software application is loaded onto a mobile computing device.

7. The method of claim 1 wherein the processor resource allocation of the client session instance is at least one full processor.

8. The method of claim 7 further wherein the at least one full processor is contained within one or more servers dedicated to solely that client session instance.

9. The method of claim 1 wherein the recipient interface and recipient rules engine are each configured to communicate with an external API.

10. The method of claim 9 wherein the recipient interface is an API and further wherein the recipient rules engine is configured to bridge communication between this API and the external API.

11. The method of claim 1 wherein the processor resource allocation of the client session is a floor and the server processors are configured to allow additional processing resources when available.

12. The method of claim 11 wherein the additional processing resources are allocated according to a priority hierarchy.

13. The method of claim 12 wherein the hierarchy is determined by network load balancing (NLB) techniques.

14. The method of claim 12 wherein the hierarchy is determined by contract and subscription terms.

15. The method of claim 11 wherein the additional processing resources are allocated according to a schedule.

16. The method of claim 15 wherein the schedule is determined by calculating the comparative average load expectations during a given day.

17. The method of claim 1 wherein the user generated message is automated.

18. A financial information exchange (FIX) service system comprising:
a backend infrastructure, the infrastructure comprising:
one or more servers each comprising one or more processors and some amount of non-transitory storage media; and
an internal network;
wherein:
each server beyond the first is interconnected with the first and each subsequent server through the internal network;
the servers are configured to dynamically allocate processing resources; and
the servers are accessible from outside the internal network by connection to external networks;
a client session instance, the instance comprising:
a user interface;
a session configuration;
a session rules engine;
a routing rules engine; and
a processor resource allocation;
wherein:
the session configuration is stored on the non-transitory storage media of the servers;
the processors on the servers are configured to execute the session rules engine according to the processor resource allocation for the client session;
the processors on the servers are configured to route messages from the user through the routing rules engine;
the user interface is configured to allow the user to remotely manage the session configuration, session rules engine, routing rules engine, and processor resource allocation from an external network;
the user interface is configured to enable the user to compose, send, and peruse messages within the interface;
and
a destination session instance, the instance comprising:
a recipient interface; and
a recipient rules engine;
wherein:
the recipient interface is configured to allow a recipient to receive and/or reply to messages within the interface;
the recipient rules engine is configured to enable the backend infrastructure to interface with the recipient; and
the processors on the servers are configured to execute the recipient rules engine;
wherein:
a message is input through the user interface;
the message is processed for transmission by the session rules engine according to the session's designated processor resource allocation;
the message is routed to its destination as determined by the routing rules engine;
the message is processed for any recipient requirements by the recipient rules engine;
the message is transmitted to a recipient through the recipient interface.

19. A financial information exchange (FIX) service deployment method comprising:
providing a backend infrastructure, the infrastructure comprising:
one or more servers each comprising one or more processors and some amount of non-transitory storage media;
an internal network; and
an internal network configuration;
wherein:
servers beyond the first are interconnected with the first and each other through the internal network;
the servers are configured to process registration information for approval or denial;
the servers are configured to test network resources and calculate load balancing algorithms then adjust their settings;
the servers are accessible from outside the internal network by connection to external networks; and
the internal network configuration is stored on the non-transitory storage media of the servers;
and
providing a user interface;
providing one or more client session instances, each instance comprising:
a session configuration;
a session rules engine;
a routing rules engine; and
a processor resource allocation;
wherein:
the session configuration is stored on the non-transitory storage media of the servers;
the processors on the servers are configured to test the session rules engine and processor resource allocation;
the servers are configured to deploy new and changed configuration selections by instantiating new sessions and overwriting prior configurations;
the user interface is configured to allow a user to remotely manage the session configuration, session rules engine, routing rules engine, and processor resource allocation from an external network;
the user interface is configured to enable a user to register users and create or configure client session instances; and
the user interface is configured to access one or more client session instances;
wherein:
a user accesses the user interface;
the user chooses to register zero or more users wherein
the user provides registration information through the user interface; and
the servers process the registration for approval;
the user chooses to configure zero or more client session instances wherein
the user chooses whether to create a new client session instance;
the user selects a client session instance to configure;
the user chooses configuration options for the selected client session instance;
the user designates rules for the selected client session instance;
the user tests zero or more rules for the selected client session instance;
the user designates routing rules for the selected client session instance;
the user chooses configuration options for the processor resource allocation of the selected client session instance; and
the user tests the processor resource allocation for the client session instance;
the user repeats this process until the one or more client session instances are configured;
the user then deploys the new and altered configurations;
the servers test and calculate adjustments to the internal network configuration to account for changes introduced by the user;
the servers finalize the internal network configuration to account for results of the prior tests and calculations.

20. The method of claim 19 wherein the user may choose to purchase additional processing resources for one or more client session instances.
